(19) United States
(12) Patent Application Publication
(10) Pub. No.: US 2012/0185116 A1
(43) Pub. Date: Jul. 19, 2012

(54) INTEGRATED BLEED AND ENGINE CONTROLLER

(75) Inventor: Gregory L. DeFrancesco, (US)

(73) Assignee: HAMILTON SUNDSTRAND CORPORATION, Windsor Locks, CT (US)

(21) Appl. No.: 13/006,808

(22) Filed: Jan. 14, 2011

(51) Int. Cl. B64D 31/06; B64D 13/00; F02C 9/18

(52) U.S. Cl. 701/3; 701/100

(57) ABSTRACT

An integrated electronic engine control and environmental control system bleed control apparatus for use with an aircraft engine. The apparatus comprises an electronic engine controller, an environmental control system bleed controller for controlling a flow of bleed air from the aircraft engine to an environmental control system located in an aircraft fuselage, and a housing for mounting on or near the aircraft engine. The housing contains both the electronic engine controller and the environmental control system bleed controller.

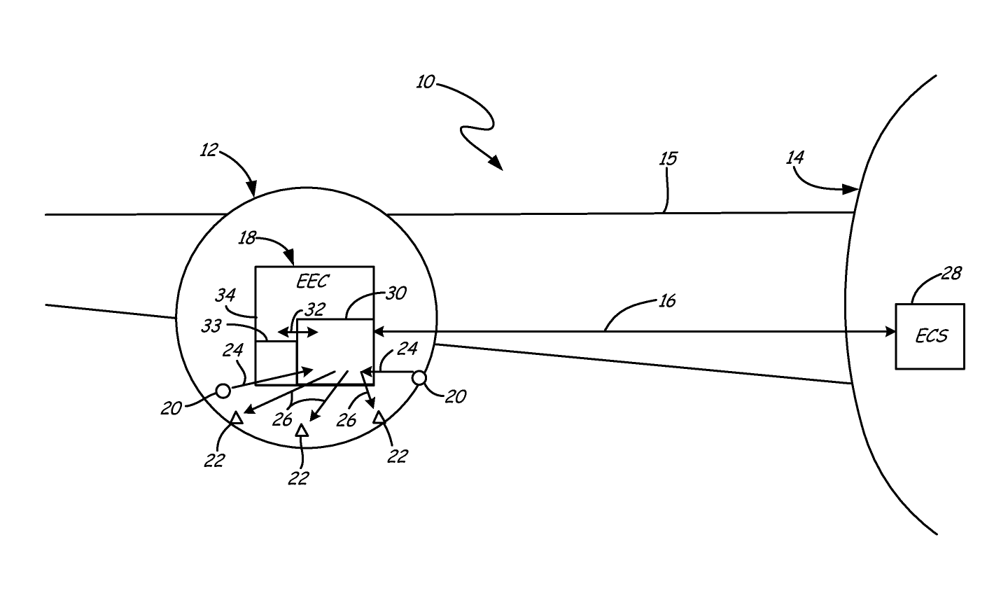

### BACKGROUND

The present invention relates to aircraft engine control systems. In particular, the invention relates to bleed air control systems for aircraft environmental control systems.

Aircraft environmental control systems maintain aircraft cabin air pressures and temperatures within a target range for the safety and comfort of aircraft passengers. This is done through the use of compressed air taken from two compressor stages (bleed air) of at least one of the bypass turbine engines propelling the aircraft. Each of the two air pressures available from the compressor, low pressure (LP) and high pressure (HP), are directed to the environmental control system (ECS) located in the fuselage through pressure lines or plenums. A pneumatic valve controller operates a series of pneumatically operated bleed valves in response to electronic control signals from the ECS through an ECS bleed controller in the fuselage to control the relative flows of LP and HP compressed air flowing to the ECS. The LP and HP bleed air as taken from the compressor is at a very elevated temperature due to the natural increase in the temperature of a gas as it is compressed. Thus, before the bleed air flows to the ECS, where it is cooled to a desired cabin temperature, it is “pre-cooled” by flowing through an air-to-air heat exchanger known as a “pre-cooler.” Cool fan air from the bypass region of the engine also flows through the pre-cooler to cool the bleed air. Air pressure in the bleed air lines is measured by at least one pressure sensor which provides this information to the ECS bleed controller. Similarly, air temperature in the bleed air lines is measured by at least one temperature sensor which provides this information to the ECS bleed controller. The ECS bleed controller uses the air pressure and temperature information along with other information from around the aircraft to direct the pneumatic valve controller to provide bleed air at a desired pressure to the environmental control system. The ECS bleed controller also directs a fan air valve to adjust the flow of fan air to the pre-cooler to provide bleed air to the ECS at a desired temperature.

### SUMMARY

An embodiment of the present invention is an integrated electronic engine control and environmental control system bleed control apparatus for use with an aircraft engine. The apparatus comprises an electronic engine controller, an environmental control system bleed controller for controlling a flow of bleed air from the aircraft engine to an environmental control system located in an aircraft fuselage, and a housing for mounting on or near the aircraft engine. The housing contains both the electronic engine controller and the environmental control system bleed controller.

### BRIEF DESCRIPTION OF THE DRAWINGS

The figure is a schematic view illustrating an embodiment of the present invention for reducing the weight of an aircraft by integrating an electronic engine control and environmental control system bleed control.

### DETAILED DESCRIPTION

A conventional ECS bleed controller located in a fuselage interfaces via electrical cabling with temperature sensors, pressure sensors, and actuators, such as torque motors controlling pneumatic valves, all located on or near the aircraft engine. The ECS bleed controller also interfaces with an ECS, also located in the fuselage. In addition, the conventional ECS bleed controller interfaces with the Electronic Engine Controller (EEC) located on or near the aircraft engine. This arrangement requires many lengthy sets of electrical cabling between the ECS bleed controller in the fuselage and sensors and actuators in the aircraft engine, compared to a few short electrical cables between the ECS and the ECS bleed controller. The present invention integrates an ECS bleed controller with an EEC. Integrating the ECS bleed controller with the EEC significantly reduces the length of electrical cabling between the ECS bleed controller and the plurality of torque motors controlling pneumatic valves, temperature sensors, pressure sensors, and the EEC, all located on or near the aircraft engine. Communication between the ECS and the ECS bleed controller is maintained over a digital data bus between the ECS bleed controller and the ECS. Replacing the bulk of electrical cabling between an ECS bleed controller and the plurality of torque motors, temperature sensors, pressure sensors, and the EEC, all located on or near the aircraft engine, with a single data bus between the ECS bleed controller and the ECS achieves a significant weight savings. The weight savings results in cost savings from reduced fuel usage. By integrating the ECS bleed controller into the EEC, additional cost and weight savings are realized by sharing a single housing for both functions, as well as internal components, for example, a power supply and a microprocessor. Finally, by reducing the total electrical cabling length, opportunities for failure associated with the lengthy electrical cables are reduced, increasing the reliability of the ECS bleed controller.

The figure is a schematic view illustrating an embodiment of the present invention for reducing the weight of an aircraft by integrating an electronic engine control and environmental control system bleed control. The figure illustrates an ECS bleed controller integrated into an EEC in an aircraft engine. The figure shows aircraft 10 comprised of engine 12, fuselage 14, wing 15, and ECS digital bus 16. Engine 12 comprises EEC 18, bleed system sensors 20, bleed system actuators 22, sensor electrical cables 24, actuator electrical cables 26 and an engine pylon (not shown). Fuselage 14 comprises ECS 28. EEC 18 comprises ECS bleed controller 30, internal digital bus 32, power supply 33, and housing 34. ECS digital bus 16 is a data bus capable of carrying digital data, for example, Ethernet, CAN, SPI, EIA/RS-485, MIL-STD-1553, IEEE 1394, and ARINC 429. EEC 18 is an electronic control device that receives engine data inputs, for example engine pressures and temperatures, and applies a set of control rules to the inputs to generate control signals for various engine functions, including fuel metering and surge control. Bleed system sensors 20 are sensors for measuring bleed air characteristics, for example, pressure sensors for measuring air pressure in the bleed air lines and temperature sensors for measuring air temperature in the bleed air lines. Bleed system actuators 22 are actuators for controlling bleed air characteristics, for example, a solenoid valve, a stepper motor, an electric motor, or a torque motor for adjusting a pneumatic bleed valve to control air pressure in the bleed air lines or a pneumatic fan air valve to control air temperature in the bleed air lines. Signals from bleed system sensors 20 and signals to bleed system actuators 22 are analog. Sensor electrical cables 24 and actuator electrical cables 26 are electrical connections for carrying analog electrical signals and are generally RF shielded to reduced electrical interference with the analog signals. ECS 28 is an electronic control device that receives data inputs associated with monitoring the aircraft cabin air pressure and temperature and applies a set of control rules to the inputs to generate bleed air pressure and temperature requirement signals. ECS bleed controller 30 is an electronic control device that receives data inputs associated with providing bleed air to the ECS and applies a set of control rules to the inputs to generate control signals for actuators controlling valves associated with providing bleed air to the ECS. Internal digital bus 32 is a data bus capable of carrying digital data, for example, Ethernet, CAN, SPI, EIA/RS-485, MIL-STD-1553, IEEE 1394, and ARINC 429. Housing 34 is any type of box or containment structure suitable for protecting electronic devices aboard an aircraft engine.

Referring to the figure, engine 12 is attached via the engine pylon (not shown) to wing 15, which is attached to fuselage 14 of aircraft 10. ECS 28 aboard fuselage 14 is electrically connected to ECS bleed controller 30 by ECS data bus 16. Bleed system sensors are electrically connected to ECS bleed controller 30 by sensor electrical cables 24. Bleed system actuators 22 are electrically connected to ECS bleed controller 30 by actuator electrical cables 26. ECS bleed controller 30 is integrated into EEC 18, with both ECS bleed controller 30 and EEC 18 contained within housing 34 and, optionally, sharing components required by both, for example, power supply 33. However, ECS bleed controller 30 and EEC 18 are logically distinct controllers operating as independent system controllers. Internal data bus 32 electrically connects EEC 18 with ECS bleed controller 30 to provide engine data from EEC 18, for example, an engine pressure, to ECS bleed controller 30.

In operation, ECS 28 generates bleed air pressure and temperature requirement digital signals necessary to maintain desired cabin pressure and temperature and transmits these signals over ECS digital bus 16 to ECS bleed controller 30. In addition to the signals from ECS 28, ECS bleed controller 30 receives analog data inputs from bleed system sensors 20 over sensor electrical cables 24. Optionally, ECS bleed controller 30 receives digital data inputs from EEC 18 over internal digital bus 32. ECS bleed controller 30 generates analog control signals as a function of at least the signals received from ECS 28 and from bleed system sensors 20. ECS bleed controller 30 transmits the analog control signals to bleed system actuators 22 over actuator electrical cables 26. ECS bleed controller 30 continues to receive analog data inputs from bleed system sensors 20 over sensor electrical cables 24 and digital data inputs from EEC 18 over internal digital bus 32 and transmit analog control signals to bleed system actuators 22 over actuator electrical cables 26 to maintain the bleed air pressure and temperature requirements of ECS 28. Digital data regarding the status of ECS bleed controller 30 and, optionally, the digital data inputs from EEC 18, are transmitted over ECS digital bus 16 to ECS 28. Also, optionally, analog data inputs from bleed system sensors 20 are converted from analog data to digital data in ECS bleed controller 30 and transmitted over ECS digital bus 16 to ECS 28.

The embodiment of the present invention described above provides several advantages by integrating ECS bleed controller 30 with EEC 18 aboard engine 12. A conventional ECS bleed controller located in a fuselage requires multiple sets of sensor and actuator electrical cabling stretching from the fuselage to the engine. In the embodiment of the present invention, these multiple sets of electrical cabling are replaced by sensor electrical cabling 24 and actuator electrical cabling 26 which need only extend within engine 18 and are, therefore, much shorter and much lighter. Data transmission between ECS 28 and ECS bleed controller 30 is handled by single data bus, ECS digital bus 16. The result is a significant wire weight savings. In addition, by integrating ECS bleed controller 30 into EEC 18, additional cost and weight savings are realized by sharing housing 34, as well as sharing components required by both, for example, power supply 33. Finally, by reducing the total length of electrical cabling, opportunities for failure associated with the conventional, lengthy multiple sets of electrical cabling are reduced, increasing the reliability of ECS bleed controller 30.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An integrated electronic engine control and environmental control system bleed control apparatus for use with an aircraft engine, the apparatus comprising:
an electronic engine controller (EEC);
an environmental control system (ECS) bleed controller for controlling a flow of bleed air from the aircraft engine to an ECS located in an aircraft fuselage; and
a housing containing the EEC and the ECS bleed controller for mounting on or near the aircraft engine.

2. The apparatus of claim 1, further comprising:
a power supply for supplying power to both the EEC and the ECS bleed controller.

3. The apparatus of claim 1, further comprising:
a digital data bus connecting the EEC to the ECS bleed controller.

4. A system for controlling an aircraft cabin environment, the system comprising:
an environmental control system (ECS) located in an aircraft fuselage;
an integrated electronic engine controller (EEC) and ECS bleed control apparatus, the apparatus comprising:
an EEC;
an ECS bleed controller; and
a housing containing the EEC and the ECS bleed controller for mounting on or near an aircraft engine; and
a first digital data bus electrically connecting the ECS to the ECS bleed controller, wherein the ECS bleed controller controls a flow of bleed air from the aircraft engine to the ECS in response to data transmitted over the digital data bus.

5. The system of claim 4, further comprising:
a sensor electrically connected to the ECS bleed controller for measuring a bleed air characteristic; and
an actuator electrically connected to the ECS bleed controller for controlling the bleed air characteristic;
wherein the ECS bleed controller controls bleed air for the ECS by sending an actuating electrical signal to the actuator, wherein the actuating electrical signal is a function of at least a sensor electrical signal received from the sensor and the data transmitted over the first digital data bus.

6. The system of claim 5, wherein the ECS bleed controller converts the sensor electrical signal into sensor digital data and transmits the sensor digital data to the ECS over the first digital data bus.

7. The system of claim 5, wherein the sensor comprises at least one of a pressure sensor and a temperature sensor.

8. The system of claim 5, wherein the actuator comprises at least one of a solenoid valve, a stepper motor, a torque motor, and an electric motor.

9. The system of claim 5, wherein the ECS bleed controller converts the sensor electrical signal into sensor digital data and transmits the sensor digital data to the ECS over the first digital data bus.

10. The system of claim 4, further comprising:
a second digital data bus connecting the EEC to the ECS bleed controller.

11. A method of controlling a flow of bleed air from an aircraft engine to an environmental control system (ECS), the method comprising:
generating a bleed air requirement signal in the ECS located in an aircraft fuselage;
transmitting the bleed air requirement signal over a digital data bus to an ECS bleed controller within an electronic engine controller (EEC) located on or near the aircraft engine;
receiving the bleed air requirement signal at the ECS bleed controller;
controlling the flow of bleed air from the aircraft engine to the ECS with a signal transmitted from the ECS bleed controller to an actuator located on or near the aircraft engine, wherein the signal transmitted from the ECS bleed controller is in response to the received bleed air requirement signal.

12. The method of claim 11, wherein controlling the flow of bleed air from the aircraft engine to the ECS with a signal transmitted from the ECS bleed controller to an actuator located on or near the aircraft engine, wherein the signal transmitted from the ECS bleed controller is in response to the received bleed air requirement signal comprises:
measuring a bleed air characteristic with a sensor located on or near the aircraft engine;
generating a sensor electrical signal as a function of the measured bleed air characteristic;
transmitting the generated sensor electrical signal to the ECS bleed controller;
receiving the sensor electrical signal at the ECS bleed controller;
generating an actuator electrical signal in the ECS bleed controller, wherein the actuator electrical signal is a function of at least the bleed air requirement signal and the sensor electrical signal;
transmitting the actuator electrical signal to the actuator controlling the bleed air characteristic;
controlling the bleed air characteristic with the actuator in response to the actuator electrical signal.
